(19) United States
(12) Patent Application Publication
(10) Pub. No.: US 2010/0258268 A1
(43) Pub. Date: Oct. 14, 2010

(54) TEMPERATURE ADJUSTABLE CUP HOLDER HAVING MEMORY CARD READABLE FUNCTION

(76) Inventor: HSIN-JEN LI, Taichung City (TW)

Correspondence Address: Chien-Hui Su, P. O. Box 70-121 Taichung, Taichung City, 40899, TW

(21) Appl. No.: 12/422,285

(22) Filed: Apr. 12, 2009

(51) Int. Cl. F25B 29/00; H05B 1/00; G06F 1/16; H01R 33/00

(52) U.S. Cl. 165/64; 248/311.2; 361/679.31; 219/385; 439/638

(57) ABSTRACT

A temperature adjustable cup holder having a memory card readable function includes a base and a cover mounted on the base. The base has a fan device received therein. A fin radiator is mounted on the fan device. A controlling chip is contactingly mounted on the fin radiator. The fan device electrically connected to the controlling chip. The cover has a cup seat disposed thereon. The cup seat contacted with the controlling chip. The cover has a connecting port and a switch disposed on a side thereof. A memory card reader is pivotally received in the base. The memory card reader has multiple sockets disposed thereon for connecting to different standards of memory cards.

### BACKGROUND OF THE INVENTION

1. Field of the Invention

The present invention relates to a cup holder, and more particularly to a temperature adjustable cup holder having a memory card readable function.

2. Description of Related Art

A conventional cup holder is used in a car. The conventional cup holder includes a container receptacle and an attachment bracket. The attachment bracket includes a positioning element and a locking element. The attachment bracket can be positioned on a rack in the car and the container receptacle can be maneuvered by the positioning element until locked into place by the locking element.

The conventional cup is served for a hot beverage, such as a cup of hot coffee which has a temperature near boiling temperature prior to service. However, the temperature of the hot beverage is decreased due to a thermal radiation when staying in a cold environment. The flavor the beverage is changed and is not the same with that in the boiling temperature. Additionally, the conventional cup holder is served for a cold beverage, such as a cup of cold cola which has a freezing temperature. However, the temperature of the cold beverage is increased due to the thermal radiation from an outer environment when staying in a hot environment. The taste of the beverage is changed. Furthermore, the carbon dioxide added in the carbonated beverage is evaporated due to the high temperature of the environment.

The present invention has arisen to mitigate and/or obviate the disadvantages of the conventional cup holder.

### SUMMARY OF THE INVENTION

The main objective of the present invention is to provide an improved temperature adjustable cup holder having a memory card readable function.

To achieve the objective, a temperature adjustable cup holder having a memory card readable function in accordance with the present invention comprises a base and a cover mounted on the base. The base has a fan device received therein. A fin radiator is contactingly mounted on the fan device. The fin radiator has multiple fins extending therefrom. A controlling chip is contactingly mounted on the fin radiator. The fan device is electrically connected to the controlling chip. A cover is mounted on base and positioned on the controlling chip. The cover has a cup seat disposed thereon. The cup seat has a bottom contacted with a top of the controlling chip. The cover has a connecting port and a switch disposed on a side thereof. The connecting port and the switch are electrically connected to the controlling chip. The connecting port is adapted to provide for connecting a power source. The switch is provided for switching the controlling chip on/off. A memory card reader is pivotally received in the base for adapting to communicate data with a computer. The memory card reader has multiple sockets disposed thereon for suitably adapting to connect to different standards of memory cards. The memory card reader is electrically connected to controlling chip and electrically connected to the connecting port via the controlling chip.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a temperature adjustable cup holder having a memory card readable function in accordance with the present invention;

FIG. 2 is an assembled perspective view of the temperature adjustable cup holder having the memory card readable function in accordance with the present invention;

FIG. 3 is an assembled perspective view of the temperature adjustable cup holder having the memory card readable function in accordance with the present invention in another direction;

FIG. 4 is an operational perspective view of FIG. 3;

FIG. 5 is a cross-sectional view of the temperature adjustable cup holder having the memory card readable function of the present invention taken along line 5-5 in FIG. 3;

FIG. 6 is a cross-sectional view of the temperature adjustable cup holder having the memory card readable function of the present invention taken along line 6-6 in FIG. 4; and

FIGS. 7-8 are operational views of the temperature adjustable cup holder having the memory card readable function in accordance with the present invention.

### DETAILED DESCRIPTION OF THE INVENTION

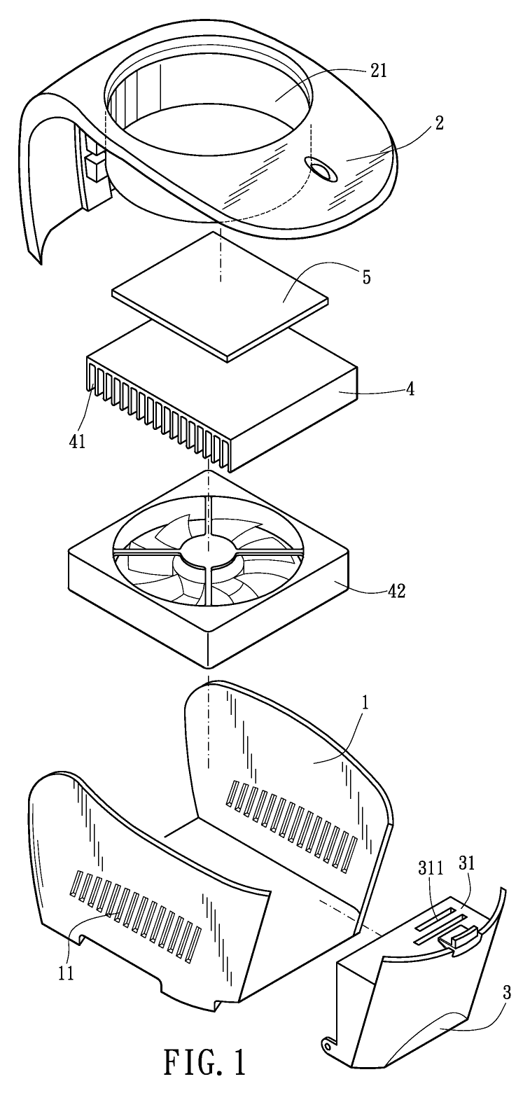

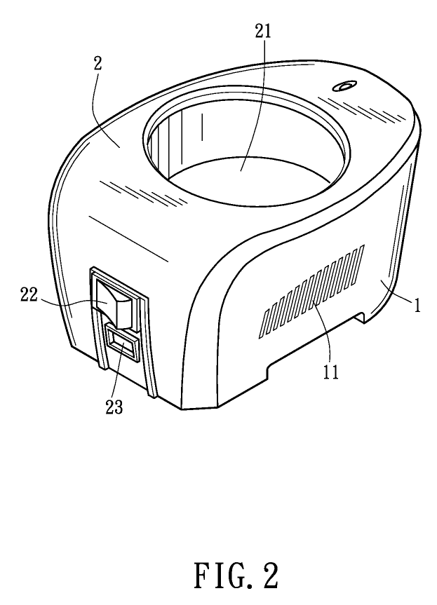

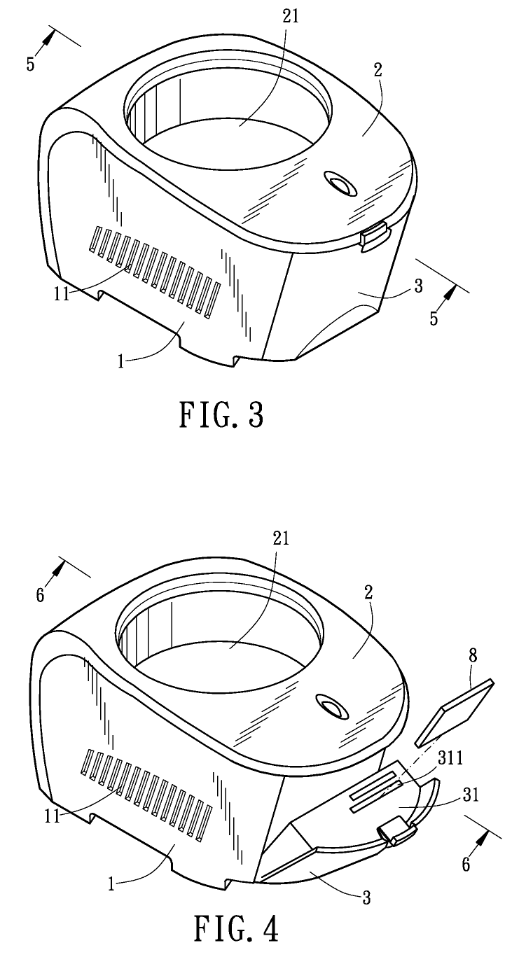

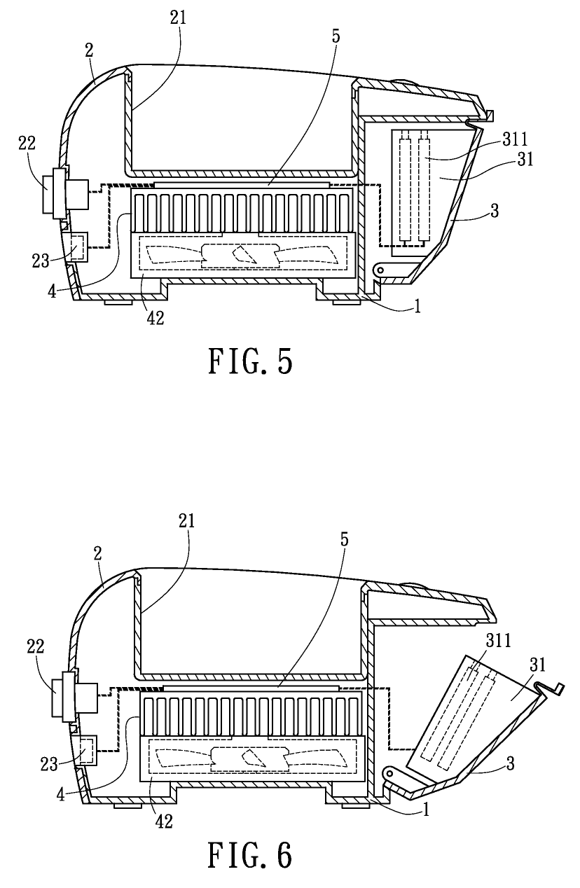

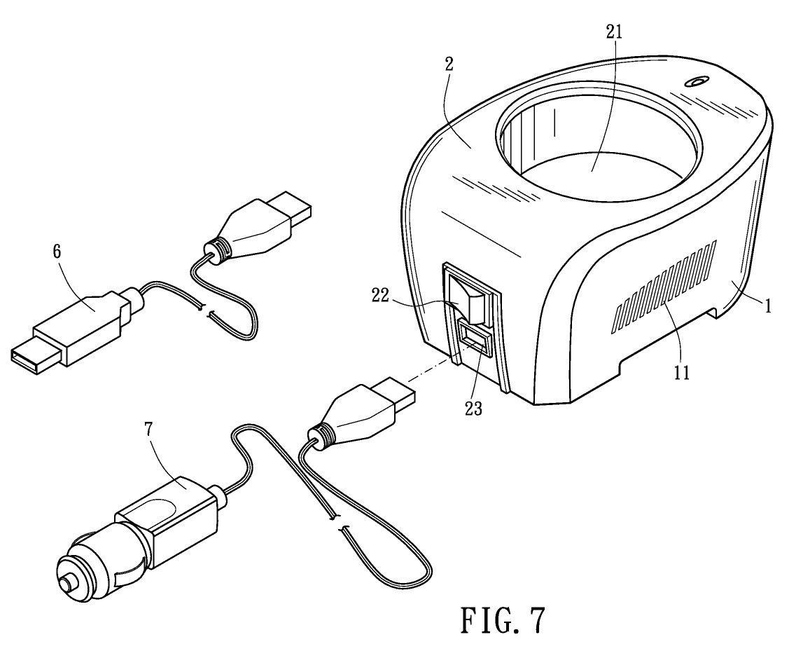

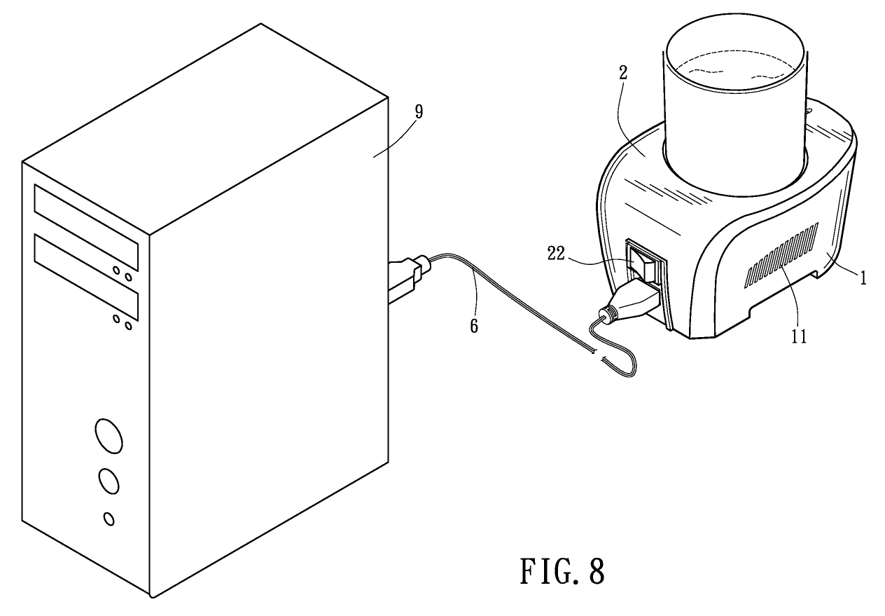

Referring to the drawings and initially to FIGS. 1-8, a temperature adjustable cup holder having a memory card readable function in accordance with the present invention comprises a base 1 and a cover 2 mounted on the base 1.

The base 1 has multiple slots 11 defined in two sides thereof. The base 1 has a fan device 42 received therein. The slots 11 in the base 1 are provided for allowing air exhausting from fan device 42. The base 1 has a pivotal seat 3 pivotally connected to a side thereof. The pivotal seat 3 is selectively received in the base 1. The pivotal seat 3 has a memory card reader 31 mounted on the pivotal seat 3 for selectively received in the base 1 to selectively prevent from exposing. The memory card reader 31 is provided for adapting to communicate data with a computer 9. The memory card reader 31 has multiple sockets 311 disposed thereon for suiting different standards of memory cards 8 inserted into the multiple sockets 311. A fin radiator 4 is contactingly mounted on a top of the fan device 42 for radiating heat. The fin radiator 4 has multiple fins extending from a bottom thereof. The fin radiator 4 has multiple grooves 41 respectively defined therein. Each groove 41 is defined in between two adjacent fins for increasing a radiated area of the fin radiator 4. A controlling chip 5 is contactingly and tightly mounted on the fin radiator 4. In the preferred embodiment of the present invention, the controlling chip 5 has a thermoelectric cooling chip (not numbered). The fan device 42 and the memory card reader 31 are electrically connected with the controlling chip 5.

The cover 2 is positioned on the controlling chip 5. The cover 2 has a cup seat 21 disposed thereon. The cup seat 21 has a bottom contacted with a top of the controlling chip 5. The cup seat 21 is selectively heated/cooled by the controlling chip 5. The cover 2 has a connecting port 23 and a switch 22 disposed on a side thereof. In the preferred embodiment of the present invention, the connecting port 23 is a Universal Serial Bus. The connecting port 23 and the switch 22 are electrically connected to the controlling chip 5. The memory card reader 31 is electrically connected to the connecting port 23 via the controlling chip 5. The connecting port 23 is provided for connecting to a computer 9 and providing for connecting a power source. The switch 22 is provided for switching the controlling chip 5 on/ff and switching heating/cooling of the controlling chip 5 for adjusting a temperature of the cup seat 21.

The cup seat 21 is provided for receiving a cup or a can. The connecting port 23 is provided for connecting a power source. The controlling chip 5 is electrified to heat/cool the cup seat 21. The switch 22 is provided for switching on/off the power source and heating/cooling of the controlling chip 5. The thermoelectric cooling chip of the controlling chip 5 is electrified to produce a heating surface and a cooling surface respectively formed on two sides of the controlling chip 5. When the electrode is reversed, the heating surface and the cooling surface are exchanged to each other. When the heating surface contacts with the cup seat 21, the cup received in the cup seat 21 is heated. When the cooling surface contacts with the cup seat 21, the cup received in the cup seat 21 is cooled and the heat of the heating surface contacted with fin radiator 4 is conductively radiated. The heat radiated from fin radiator 4 is exhausted by the fan device 42 via the slots 11.

The temperature adjustable cup holder having the memory card readable function in accordance with the present invention further comprises a Universal Serial Bus connector 6. The Universal Serial Bus connector 6 has one end selectively connected to the connecting port 23 and the other end selectively connected to the computer 9 for communicating data between the memory card reader 31 and the computer 9. The Universal Serial Bus connector 6 is provided for conducting computer's power to the controlling chip 5 via the connecting port 23. When the connecting port 23 is electrically connected to the computer 9 via the Universal Serial Bus connector 6, the memory card reader 31 is electrically connected to computer 9 via the controlling chip 5, the connecting port 23, and the Universal Serial Bus connector 6 for communicating data between the memory card 8 and the computer 9. User can directly insert the memory card 8 into the socket 311 of the memory card reader 31 for communicating data with the computer 9 without detaching the Universal Serial Bus connector 6 from the computer 9.

The temperature adjustable cup holder having the memory card readable function in accordance with the present invention further comprises a car power connector 7. The car power connector 7 has one end selectively connected to the connecting port 23 and the other end connected to a car cigarette lighter socket for providing for conducting car's power to the controlling chip 5 via the connecting port 23.

The memory card reader 31 is pivotally and selectively received in the base 1 to prevent the memory card reader 31 from damaging due to a crashing. It also prevents water from soaking into the memory card reader 31.

Although the invention has been explained in relation to its preferred embodiment, it is to be understood that many other possible modifications and variations can be made without departing from the spirit and scope of the invention as hereinafter claimed.

What is claimed is:

1. A temperature adjustable cup holder having a memory card readable function comprising:
a base, the base having a fan device received therein, a fin radiator contactingly mounted on the fan device for radiating heat, the fin radiator having multiple fins extending therefrom, two adjacent fins having a groove defined therebetween for increasing a radiated area of the fin radiator, a controlling chip contactingly and tightly mounted on the fin radiator, the fan device electrically connected to the controlling chip;
a cover mounted on the base and positioned on the controlling chip, the cover having a cup seat disposed thereon, the cup seat having a bottom contacted with a top of the controlling chip, the cover having a connecting port and a switch disposed on a side thereof, the connecting port and the switch electrically connected to the controlling chip, the connecting port adapted to provide for connecting a power source, the switch provided for switching the controlling chip on/off; and
a memory card reader adjustably connected to the base for adapting to communicate data with a computer, the memory card reader having multiple sockets disposed thereon for suitably adapting to connect to different standards of memory cards, the memory card reader electrically connected to controlling chip and electrically connected to the connecting port via the controlling chip;
wherein the cup seat is provided for receiving a cup, the controlling chip provided for heating/cooling the cup seat for adjusting a temperature of the cup seat, the switch selectively switched for controlling the controlling chip to heat/cool the cup seat.

2. The temperature adjustable cup holder having the memory card readable function as claimed in claim 1, wherein the base has a pivotal seat pivotally connected to a side thereof, the pivotal seat selectively received in the base, the memory card reader mounted on the pivotal seat for selectively received in the base to prevent from exposing.

3. The temperature adjustable cup holder having the memory card readable function as claimed in claim 1, wherein the base has multiple slots defined in two sides thereof for allowing air exhausting from the fan device.

4. The temperature adjustable cup holder having the memory card readable function as claimed in claim 1 further comprising a Universal Serial Bus connector, the Universal Serial Bus connector having one end selectively connected to the connecting port and the other end adapted to selectively connect to the computer for communicating data between the memory card reader and the computer, the Universal Serial Bus connector provided for conducting computer's power to the controlling chip via the connecting port.

5. The temperature adjustable cup holder having the memory card readable function as claimed in claim 1 further comprising a car power connector, the car power connector having one end selectively connected to the connecting port and the other end adapted to selectively connect to a car cigarette lighter socket for conducting car's power to the controlling chip via the connecting port.
